(19) United States
(12) Patent Application Publication
(10) Pub. No.: US 2011/0203319 A1
(43) Pub. Date: Aug. 25, 2011

(54) METHOD OF RECYCLING MIXED COLOR CULLET USING COPPER OXIDE

(75) Inventor: Richard Lehman, Princeton, NJ (US)

(73) Assignee: CULCHROME, LLC, Bryn Mawr, PA (US)

(21) Appl. No.: 12/711,763

(22) Filed: Feb. 24, 2010

(51) Int. Cl. C03B 23/00

(52) U.S. Cl. 65/28

(57) ABSTRACT

Green glass content of mixed color glass cullet is selectively decolorized by using copper oxide and is used as an input component in a conventional glass production process. To determine how much copper oxide to add, the weight percent of green glass in the provided glass cullet supply is determined and an effective amount of copper oxide to, at least partially, decolorize the green glass is determined wherein an effective amount is determined using a non-linear inverse prediction model between the weight percent of green glass or chromium and/or iron content and the copper oxide. The amount of copper oxide is thus non-linearly adjusted for increasing levels of green glass in the glass batch. To compensate for the darkening of the glass by the additional copper oxide, the redox of the glass may be made slightly less reducing as the amount of chrome and copper is increased.

### FIELD OF THE INVENTION

The present invention relates to the field of glass production. In particular, the present invention relates to a method of selectively, and at least partially, color-neutralizing green glass using copper oxide. Certain presently preferred embodiments of the current invention, relate to methods of selectively and, at least partially, decolorizing green glass within mixed cullet used in the production of amber glass.

### BACKGROUND OF THE INVENTION

Cost-effective recycling of materials, such as glass, has become an increasingly important issue because of stresses on the environment and scarcity of resources. Increased recycling of materials reduces the amount of materials, such as glass, plastics, paper, etc., that enters landfills or other waste-disposal points. Additionally, recycling significantly reduces the need for manufacturers to use “virgin” materials, and thus preserves environmental resources. Further, the use of recyclables in place of virgin raw materials often reduces energy requirements, eliminates process steps, and reduces waste streams, including air emissions during product manufacturing. For example, recycled glass requires less energy and emits fewer contaminants during the glass manufacturing process than virgin raw materials do. Many states now require glass container manufacturers to use a minimum percentage of post-consumer cullet, which is broken pieces of glass.

However, glass quality and homogeneity are major concerns since most cullet is derived from consumer waste. Often, the glass coming into a material recovery facility (MRF) and/or a glass processing facility, i.e., a site where cullet is cleaned and prepared for shipment to glass manufacturers is broken, contaminated with other materials, and of mixed color. Prohibitive sorting costs have made it difficult for suppliers to process an adequate quantity of single-colored recycled glass.

To date, three-color mixed cullet in post-consumer solid municipal waste has had only limited commercial use. For example, mixed cullet may typically be used only as an aggregate in paving material, landfill cover, or some similar use, but often is discarded in landfills. Mixed color cullet, as discussed herein, comprise broken pieces of glass of mixed colors and types, typically green, amber, and flint (i.e., colorless) glass. The mixed colored material is substantially less valuable than color-sorted cullet.

In post-consumer solid municipal waste, there are vast amounts of waste glass that are contaminated with green glass commingled with other colors. The percent green may be, for example, up to 25% of the total mixture. However, green glass has very low market value because it has few end uses. Previously known techniques of removing such high levels of green glass may be impractical and negatively impact manufacturing process factors such as equipment expense, process complexity and efficiency. It would be beneficial if the green glass could be converted into, for example, amber glass which has a much higher market value in the industry because amber glass is more widely used, for example, in the manufacture of beer bottles. What is needed is a way of using the mixed color glass without the expense of removing the green glass component, thereby imparting greater market value to the green glass-containing mixed glass for use in making amber glass. This may further generate a market for mixed cullet having a high percentage of green glass which would otherwise be discarded.

The glass end user, or bottler, provides color specifications to the bottle suppliers, i.e., glass manufacturers. The bottle suppliers then tune their manufacturing process to produce glass to meet these target-color specifications. If the supply of mixed colored glass contains a high-percentage green glass, a technical challenge exists to meet the color specification for amber glass. Consequently, without a way to meet the color specifications using a high percentage of green glass, that cullet is not useable and is consequently shipped to a landfill or used in paving. What is needed is a way to meet the color specifications of the end product even when the supply of mixed colored glass contains a high percentage of green glass, thereby avoiding a green tint within an amber glass product.

Glass manufacturers are now able to develop glass recycling processes and formulations to address mixed color cullet or single-colored glass received by glass manufacturers. For example, one method of analyzing mixed cullet is described in U.S. Pat. No. 6,230,521, herein incorporated by reference in its entirety. Glass manufacturers now desire to develop glass batch recipes or formulations from mixed color cullet, having a known color distribution, for manufacturing end products. Additionally, a process for using mixed colored glass, wherein mixed cullet is used like color-sorted cullet, to make new and useful glass products would be beneficial. In addition to many previously known sorting techniques, methods to selectively colorize and/or decolorize one or more colors present within mixed cullet would be beneficial in rendering the cullet useful in the manufacture of glass products. More specifically, there is a need in the art for improved techniques to selectively and, at least partially, decolorize green glass content of mixed color cullet used in the production of amber glass.

In U.S. Pat. No. 2,929,675 (Wranau, et al.), a method is disclosed for spinning glass fibers using a fluid molten glass, which glass is optically enhanced by decolorizing the glass to make it more transparent or translucent, so that infra-red rays of the radiant heat supply more readily pass through the glass for heating the spinnerette. In the Wranau method, glass having a greenish tint is decolorized by the addition of effective decolorizing amounts of such materials as selenium oxide, manganese peroxide, copper oxide or dispersed gold to the molten glass.

In U.S. Pat. No. 2,955,948 (Silverman), a glass decolorizing method is disclosed which continuously produces molten color-controlled homogeneous glass. In the Silverman method, flint (colorless) and other container glass is decolorized by addition to the molten glass of a selenium-enriched frit as a decolorizing agent, as opposed to selenium in its free state mixed with virgin batch raw materials. This is considered to better retain the selenium in the finished goods without vapor loss thereof. Silverman discloses that various commonly used materials for decolorizing flint glass have been tried to eliminate selenium vapor losses without success, such as various selenium compounds, e.g., sodium and barium selenates and selenides, as well as arsenic, by reducing the iron oxide inherently present therein. Silverman discloses that the decolorizing agent preferably comprises frit compositions containing the essential decolorizing agent selenium in its Se⁺⁴ valence state, and also may contain niter and arsenic. In Silverman's method, the decolorizing agent of selenium-enriched frit is added to the molten flint glass and dispersed therein in order to decolorize the glass.

In U.S. Pat. No. 3,482,955 (Monks), a method is disclosed for decolorizing the ferrous (Fe⁺²) oxide content of soda-lime glass which naturally contains up to about 0.1% by weight of ferrous oxide. The Monks method continuously produces decolorized homogeneous glass using a manganese-enriched frit glass as the decolorizing agent. Monks, in particular, provides a method of decolorizing soda-lime glass containing iron as the impurity by utilizing a decolorizing frit glass containing manganese that produces no undesirable coloration of its own and adding the decolorizing frit glass to the molten base glass. Monks teaches that decolorizing frit glass preferably comprises oxidized manganese in the Mn⁺³ state (Mn₂0₃) and in the Mn⁺² state (MnO), which acts as an oxidizing agent to oxidize ferrous iron to ferric iron in soda-lime glass.

Decolorizing techniques are known to remove the tint due to those iron impurities which tend to impart a bluish or greenish hue to “colorless” flint glass. Nonetheless, in the manufacture of colorless glass, particularly soda-lime-silica flint glasses, the presence of iron as an impurity in the raw materials has been a serious problem. The presence of ferrous iron (Fe⁺²) tends to cause a bluish or blue-green discoloration in the finished glass in addition to decreasing its overall brightness. The economics of glass manufacture are such that it is difficult to provide low cost raw materials free from these iron impurities, unfortunately most significant deposits of sand and limestone contain at least trace amounts of various iron salts and oxides.

During the glass manufacturing process, raw materials are melted in the glass batch at temperatures of about 2,600° to 2,900° F. (about 1,400° to 1,600° C.), and significant amounts of iron present are converted to the ferrous (Fe⁺²) state under the influence of the prevailing equilibrium conditions. Decolorizers and oxidizers can be added to the glass batch in an attempt to oxidize the ferrous (Fe⁺²) iron, thereby forming ferric (Fe⁺³) iron, to minimize this glass coloration. Ferric iron (Fe⁺³) is a relatively much weaker colorant than ferrous iron. Decolorizing to minimize the tint caused by trace iron-containing impurities, such as small amounts of ferrous iron, is a less severe problem than decolorizing or offsetting recycled glass that has been heavily tinted by the addition of tint producing compounds, such as chromium green found in high concentrations in green glass. A sufficient treatment with those previously known decolorizing compositions may be difficult to achieve without also affecting the clarity of the glass or causing other quality and manufacturing problems. Thus, there has been a long felt need in the art for methods of decolorizing green glass, and especially high levels of green glass which may be found in mixed color cullet, while still maintaining desired end product quality.

A more recent method of selectively decolorizing mixed color cullet is found in U.S. Pat. No. 5,718,737, entitled “Method of recycling mixed colored cullet into amber, green, or flint glass,” herein incorporated by reference. The '737 patent describes how mixed colored cullet glass, which generally contains amounts of green, amber and flint glass, is recycled into amber-colored glass by regulating the additive amounts of iron, carbon, sulfur, or compounds of these elements in the mixture in order to impart the desired reddish-brown hue. The color green may be selectively decolorized from the mixed colored cullet and the mixed colored cullet may be colorized for the color amber, thereby rendering the decolorized mixed colored cullet substantially amber-colored for use in amber-colored glass production, such as amber soda lime glass colored with reduced iron sulfur compounds.

Another recent method of selectively decolorizing mixed color cullet is found in U.S. Pat. No. 6,230,521, entitled “Method of recycling batches of mixed color cullet into amber, green, or flint glass with selected properties,” incorporated herein by reference. The '521 patent describes an automated method for recycling mixed colored cullet glass using a computer-controlled process which identifies the virgin glass raw materials, the desired target glass properties, the composition of a batch of mixed colored cullet, and the quantity of cullet to be used in the glass melt; the computer-controlled process then determines the proper amounts of raw materials to add to the batch of mixed colored cullet so that recycled glass is produced having the desired coloring oxides, redox agents, and glass structural oxides in the proper proportion. The recycled glass is then used to make glass products, such as beer bottles.

While these previously known methods describe suitable ways of using mixed color cullet containing green glass, none provide improved and effective ways of using cullet, having a traditionally unusable percentage of green glass, in the manufacture of glass products using copper oxide as now taught. Copper oxide is particularly well suited for maintaining the desired color of amber glass melted with a high fraction of green cullet. Copper oxide is a red colorant in bottle glass under reducing conditions, such as those found in reduced iron sulfide amber container glass, and copper oxide is comparatively less expensive than other red colorants such as selenium or gold. This reddish coloration is required to compensate for the chrome oxide contained in the green cullet.

There is a need in the art for methods of recycling mixed cullet having traditionally high levels of green glass, thereby reducing or eliminating the amount of commingled cullet that is discarded because its use does not meet color specifications. There is a further need in the art for methods of using mixed color glass cullet without the added expense or complexity of removing green glass constituents, thereby imparting greater market value to green glass-containing cullet for use in making amber glass.

There is also a need in the art for a method, as now taught, of at least partially neutralizing traditionally high levels of green glass in an amber glass batch, thereby providing an improved technique for converting mixed color cullet, having green glass, to amber glass. In particular, there is a need for a method of producing amber glass of good color and of acceptable redness ratio from raw materials containing greater than 5% green cullet, thereby reducing or eliminating green color tinting of amber glass products produced therefrom.

### SUMMARY OF THE INVENTION

Certain preferred embodiments of the present invention are particular suited for selectively and, at least partially, decolorizing green glass content of mixed color glass cullet by using copper oxide (CuO or Cu₂O) in a conventional amber glass production process. The inventor has surprisingly found, through non-routine experimentation, that an effective amount of copper oxide may be used to selectively, and at least partially, decolorize green glass content of mixed color cullet. More specifically, an effective amount of decolorizing copper oxide is preferably determined according to a non-linear relationship to the weight percent of green glass in the mixed color cullet. It has been found that an inverse prediction model of copper oxide addition level may be determined from chrome oxide and the targeted redness ratio. Certain preferred methods of the present invention use copper oxide at the calculated levels to at least partially neutralize the color effects of high levels of green glass within three-color mixed cullet used in the production of amber glass products, such as beer bottles.

Certain embodiments of the present invention include the steps of determining the percent green in the mixed cullet, determining the percent green in the overall batch, determining the amount of copper oxide required within the glass formulation using the inverse prediction model, adjusting the remaining color additives within the glass formulation, developing the overall glass formulation, manufacturing the glass product, measuring the color characteristics, determining whether the color measurements are within specification, and adjusting the overall glass formulation if necessary.

In an exemplary embodiment, the method of recycling mixed color cullet includes the steps of providing a glass cullet supply comprising green glass, determining the weight percent of green glass in the glass cullet supply, and determining an effective amount of copper oxide to, at least partially, decolorize the green glass wherein the effective amount is determined according to a non-linear relationship between at least the weight percent of green glass and the copper oxide. The non-linear relationship may be determined in accordance with the following polynomial equation:

Y=X₀+CO*GG*X_{C1}+(0.0021*GG)²*X_{C2}+XS*X_{X1}+XS²*X_{X2}

where:

Y is the amount of copper oxide, as a percent of total glass weight, added to produce an excess redness ratio XS of given value when the green glass content, as a percent of total glass weight, is GG;

CO is the amount of chrome oxide, as a percent of total glass weight, as a percent of total glass weight;

GG is the green glass content of the batch of glass expressed as a percentage of total glass weight;

XS is the desired excess redness ratio of the melted glass defined as the difference between a measured redness ratio (T650/T550) and an amber glass minimum acceptable redness ratio as defined by a target amber glass specification;

X₀ is an intercept with a Y axis;

X_{C1} is a chrome linear value;

X_{C2} is a chrome quadratic value;

X_{X1} is a redness ratio linear value; and

X_{X2} is an excess redness quadratic value.

The exemplary embodiment may also include the further steps of specifying prior to melting of the glass supply, transmission properties of desired resultant glass products, calculating the desired amount of additional color modifiers, developing a desired glass formulation having the effective amount of copper oxide, and creating at least one recycled glass product, such as an amber beer bottle, according to the glass formulation. The method may also include the step of making a redox less reducing to maintain a glass batch produced from the method within a designated 550 nm transmission requirement as the amount of chrome and copper oxide is increased in the glass batch. The step of specifying the transmission properties of the recycled glass products may further include specifying a thickness of a recycled glass product made from the determined glass formulation and specifying at least two of (1) an optical transmission of the recycled glass product at 550 nm (T₅₅₀), (2) an optical transmission of the recycled glass product at 650 nm (T₆₅₀), and (3) a redness ratio (T₆₅₀/T₅₅₀) of the recycled glass product.

### BRIEF DESCRIPTION OF THE DRAWINGS

The foregoing and other beneficial features and advantages of the invention will become apparent from the following detailed description in connection with the attached figures, of which:

FIG. 1 illustrates a conventional glass manufacturing system within which copper oxide is used in accordance with the invention.

FIG. 2 illustrates a flow diagram of a method of using copper oxide in accordance with the invention to neutralize green glass within three-color mixed cullet used in the production of amber glass products.

FIG. 3 illustrates the amount of copper oxide required to compensate for green glass in the amber batch to meet fixed redness ratios.

FIG. 4 illustrates the amount of copper oxide required to compensate for chrome oxide in green glass to meet the fixed redness ratios.

FIG. 5 illustrates a table of the effective amounts of copper oxide to at least partially neutralize the color effects of green glass in the manufacture of amber glass, and to retain a good redness ratio, for excess redness ratios of 0, 0.1, 0.2, and 0.3, respectively.

FIG. 6 depicts a linear relationship between an effective amount of copper oxide and the amount of simulated green glass in a cullet supply.

FIG. 7 depicts an exemplary non-linear relationship between an effective amount of copper oxide and varying amounts of simulated green glass in a cullet supply.

FIG. 8 depicts an exemplary non-linear relationship between an effective amount of copper oxide and about 8% simulated green glass in a cullet supply.

FIG. 9 depicts an exemplary non-linear relationship between an effective amount of copper oxide and about 14% simulated green glass in a cullet supply.

FIG. 10 depicts an exemplary non-linear relationship between an effective amount of copper oxide and about 20% simulated green glass in a cullet supply.

FIG. 11 shows the response curve of the copper oxide, simulated green glass, and excess redness ratio system.

FIG. 12 illustrates excess redness ratios of 0, 0.1, 0.2, and 0.3 for different percentages of chrome in the glass batch.

FIG. 13 illustrates excess redness ratios of 0, 0.1, 0.2, and 0.3 for different percentages of green glass in the glass batch.

### DETAILED DESCRIPTION OF ILLUSTRATIVE EMBODIMENTS

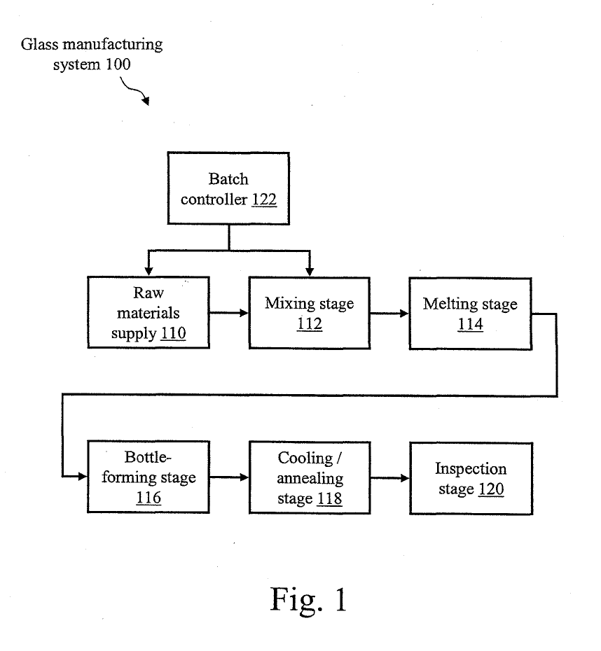

Certain aspects the present invention will be described below with reference to FIGS. 1-13. It will be appreciated by one of ordinary skill in the art that the descriptions given herein with those figures and methods of recycling mixed color cullet are for exemplary purposes only and is not intended to limit the scope of the invention in any way.

Certain preferred embodiments of the present invention are particularly suited for compensating for elevated percentages of green cullet using copper oxide in a glass production process. As used herein, copper oxide may encompass pure oxides of CuO or Cu₂O, and any number of compounds, including ores, minerals, salts, oxides, and/or polymorphs having CuO or Cu₂O. More specifically, presently preferred embodiments of the present invention use copper oxide to neutralize the color effects of traditionally undesirable levels of green glass within three-color mixed cullet used in the production of amber glass products, such as beer bottles. As a result, certain embodiments of the present invention provide improved methods for converting green glass to some other color, such as amber or even flint. Still further preferred methods of the present invention use quantitative control of the amount of copper oxide required to, at least partially, decolorize green glass content of mixed color cullet, recognizing that there is a non-linear relationship between the effective amount of copper oxide and the amount of green glass in the supplied cullet.

Typically, the ratio of clear (flint), amber, and green glass for recycling will vary according to customer use patterns and the products available in regional markets. United States glass container production yields approximately 60% clear (flint) glass, 30% amber, and 10% green. However, three-color mixed cullet compositions vary enormously depending upon collection and recycling practices and also on consumer demographics and preferences. Three-color mixed cullet flint levels are in the range of 30-60%, amber in the range of 25-55%, and green in the range of 5-25%. And, more green tends to be present in those areas that import more foreign beers and consume more wine, as on the east and west coasts of the United States.

Mixed color cullet is primarily made of soda-lime-silica glass (otherwise referred to as “soda-lime glass”) and is typically provided in bulk in the form of a plurality of broken pieces or particles, such that the cullet can be readily poured or otherwise handled and melted. Generally, at least one color may be selectively removed, neutralized, or converted in a specified batch of mixed color glass cullet by selective physical and/or chemical decolorizing, at which time, the mixed color glass cullet absent such at least one color is recovered for use in the production of new glass products.

Amber colored glass may be produced from the mixed color glass cullet by selectively decolorizing the green colorant in the mixed cullet. In particular, green glass may contain varied amounts of chromium (typically Cr₂O₃), iron (typically Fe₂O₃), or both depending on the desired color intensity as mandated by various producers of beer and wine bottles. These green colored glasses may also have elemental chromium, chromium ions, or any number of salts or oxides of chromium. Further, green glasses may have any amount of ferrous iron (Fe⁺²), ferric iron (Fe⁺³), or any number of iron salts or iron oxides. These green-containing glasses can be selectively, and at least partially, decolorized in the mixed color cullet to remove excessive green which lowers the desired redness ratio or reddish hue in amber glass used to manufacture recycled glass products, such as amber beer bottles. Further, one skilled in the art would understand the general applicability of certain aspects of the present invention to those colored glasses having some amount of chromium and/or iron, including those greenish-yellow, and greenish-blue tinted glasses known in the art.

The mixed color glass cullet is decolorized as to at least the green color, by addition to mixed color glass an effective amount of copper oxide as provided hereinafter. Preferably, a predetermined amount of mixed colored cullet glass is admixed with a virgin batch of glass containing conventional glass raw materials in the remaining color as well as an effective amount of copper oxide and possibly other colorizing and/or decolorizing agent(s) to compensate for the mixed colored cullet to produce new glass products containing a certain percentage of recycled mixed colored cullet. This is particularly effective for making amber glass containers, and the like, from mixed color cullet.

Conventional glass raw materials, such as those for amber, green, or flint soda lime-silicate glasses, and glass making equipment, such as glass melting furnaces, lehrs, forming equipment and the like, can be used with the method of the invention. For a description of glass raw materials, glass manufacture and processing techniques, reference can be made, inter alia, to S. R. Scholes, Ph.D., Modem Glass Practice, CBI Publishing Co., Inc. (1975) and Kirk-Othmer, Concise Encyclopedia of Chemical Technology, John Wiley & Sons, Inc. (1985), pp. 560-565, the disclosures of which are hereby incorporated in their entireties.

The virgin glass raw materials for amber colored glass, known to be capable of yielding glass-forming oxides, can include effective amounts of major constituents, e.g., sand, limestone, soda ash, feldspar, or the like, and minor constituents, e.g., salt cake, gypsum, carbocite, graphite, iron pyrite, calumite, or the like.

Without being limited by theory, the reddish-brown coloration of carbon-sulfur amber colored glass is believed to be attributed to its sulfate (e.g., salt cake and gypsum), carbon (e.g., carbocite, graphite and carbon black) and iron (e.g., iron oxide and iron pyrite) contents. It is believed that amber glass formation involves the colorizing reactions of the alkali sulfates with reducing agents, such as carbon, to form alkali sulfites, elemental sulfur and sulfides, as well as alkali polysulfides and sulfoferrites, which compounds are all believed to play a part in the amber coloring. In those physical decolorizing techniques known in the prior art, complementary colors are added to the green cullet to offset or neutralize the color green. Typical physical decolorizing agents known in the art include elemental or compounds of selenium (red), manganese (purple), or gold (red).

Amber container glasses absorb light in the biologically active region of 450 nm and thereby protect the container contents from chemically active ultraviolet radiation. Amber glass is produced under strong reducing conditions and typically has an oxidation/reduction potential (i.e., redox number) of about −40 to −70 and a redness ratio of in the range of 1.5-2.0.

Aspects of the present invention are especially suited for use in a glass manufacturing process having high levels of green glass within mixed cullet. FIG. 1 illustrates a conventional glass manufacturing system 100 within which copper oxide is used in accordance with the invention to at least partially decolorize, or minimize the color effects of, green glass within the mixed cullet supply. Preferred methods of the present invention are described as using three color mixed cullet. However, suitable mixed-color cullet may likewise include two-, four-, or five-color mixed cullet, or any mixed cullet having at least one color constituent other than green glass. Glass manufacturing system 100 includes a raw materials supply 110, a mixing stage 112, a melting stage 114, a bottle-forming stage 116, a cooling/annealing stage 118, an inspection stage 120, and a batch controller 122.

Raw materials supply 110 is representative of a collection of typical raw materials for making glass, such as sand, soda ash, limestone, and nepheline syenite; other additives, such as minor colorant modifiers; oxidizing agents, such as nitrates or sulfates; and reducing agents, such as coal. The raw materials from raw materials supply 110 typically have a consistency of beach sand. Raw materials supply 110 may further include some percentage of mixed cullet containing flint, amber, and green glass. Thus, an exemplary color distribution for supplied three-color mixed cullet color may be approximated as 55% flint (colorless), 30% amber, and 15% green; however, when combined with some amount of “virgin” or single color glass for batch processing, the color distribution may change accordingly.

Mixing stage 112 is representative of well-known mechanical mixers used in glass making for physically mixing the raw materials from raw materials supply 110. Also added at this stage are minor colorant modifiers, e.g. colorizers and decolorizers, such as described in reference to U.S. Pat. No. 6,230,521, entitled, “Method of recycling batches of mixed color cullet into amber, green, or flint glass with selected properties,” which is herein incorporated by reference. These modifiers may include additive amounts of iron, carbon, sulfur, and sulfur compounds in the mixture to impart the desired end product color, for example the reddish-brown hue of amber glass. This is the stage in which copper oxide is added in accordance with the invention to, at least partially, decolorize the green glass content of mixed color cullet used in the manufacture of amber glass products, such as beer bottles.

Melting stage 114 is representative of well-known furnace apparatuses used for heating and thereby melting the raw materials after they are mixed within mixing stage 112. Within melting stage 114, the raw materials combine with each other, first in a solid state, then in a solid-liquid mixture, then in a complete liquid state. The resulting liquid is then homogenized because of the very high temperatures of typically between 1400 and 1600° C.

The molten raw materials then pass from melting stage 114 into bottle-forming stage 116, in which the end product is formed from the viscous liquid via the well-known glass blowing or press and blowing process, which is a process of forming glass hollow ware from molten glass by means of an “IS machine”, which incorporates the necessary elements of pressing and/or blowing in a two stage process with appropriate molds, thereby forming a desired shape, such as a bottle shape. Once the bottles are formed, they pass from bottle-forming stage 116 to cooling/annealing stage 118, in which the amber bottles are allowed to cool at a slow, uniform rate, thereby removing stress within the glass.

Inspection stage 120 is the stage within glass manufacturing system 100 in which the end product is inspected to determine whether it meets the expected quality and color specifications. For example, one inspection operation determines the mechanical integrity of the end product. In the case of bottles, they are inspected for bubbles and cracks. This is a bottle-to-bottle inspection event. A second operation determines whether the color specification is met by using a spectrophotometer to measure the percent transmission of the glass of each individual wavelength throughout the visible spectrum, i.e., about 400 to 700 nm wavelength. The profile of this measurement defines the color of the glass, which is then compared against an expected color specification. As color is something that changes slowly because of gradual changes in a batch, this is not a bottle-to-bottle inspection; instead, the color inspection is typically a periodic inspection, which occurs every few hours.

Batch controller 122 is any conventional computer, such as a personal computer, laptop computer, or networked computer, which is loaded with control software used for storing and managing the glass formulation and mixing parameters of glass manufacturing system 100, thereby controlling the feed of raw materials from raw materials feeder 110 to mixing stage 112. The batch controller may be a stand-alone computer from which batch formulation parameters are printed out and hand entered into the plant batch weigh-out and mixing equipment, or it may be electronically integrated with the plant batch weigh-out and mixing equipment. In highly integrated glass manufacturing facilities all functions may be integrated into the overall glass plant control computer network system.

Copper oxide is used within glass manufacturing system 100 in accordance with the invention as a selective decolorizer to at least partially neutralize the color effects of green glass within the mixed cullet supply. With reference to FIG. 1, the operation of glass manufacturing system 100 for making amber glass is described. Batch controller 122 determines the overall glass formulation, using typical raw materials for manufacturing glass based upon the end-product specification, such as the color specifications. In accordance with the method of the present invention, copper oxide is used to selectively decolorizer high levels of green cullet in making amber glass. Accordingly, an input parameter to batch controller 122 regarding the color specifications is the total percent mixed cullet used in the process and, furthermore, the percent of each glass color within the mixed cullet. For example, if the total raw materials include 40% three-color mixed cullet and the three-color mixed cullet further includes 22% green, 30% amber, and 48% flint, batch controller 122 calculates the weight percent of each color within the total mixture to be 8.8% green, 12% amber, and 19.2% flint, and establishes the batch formulation accordingly.

Subsequently, under the control of batch controller 122, the specific quantity of each raw material according to the batch formulation is fed at a predetermined rate from raw materials supply 110 into mixing stage 112. Mixing stage 112 then physically mixes the raw materials as supplied from raw materials supply 110 for a predetermined period of time before delivering the blended raw materials into melting stage 114.

An effective amount of copper oxide is added to the batch at the mixing stage. Generally, green glass is colored with chromium oxide [Cr₂O₃] whereas amber glass derives its color from an iron [Fe⁺³] sulfide [S⁻²] color center. When green glass is added to amber glass, the chrome green color persists in the amber glass and reddish additives, e.g. copper, are necessary to restore the spectral balance to the amber color. Without being limited by theory, it is noted that the amount of copper oxide added is at least dependent upon the weight percent of green glass content of the total mix. Indeed, the inventor has surprisingly found though non-routine experimentation that the preferable amount of copper oxide required to, at least partially, decolorize the green glass content is non-linear in relation to the total weight percent of green glass in the batch. It has been found that an inverse prediction model of copper oxide addition level may be determined from chrome oxide and the targeted redness ratio. Certain preferred methods of the present invention use copper oxide at the calculated levels to at least partially neutralize the color effects of high levels of green glass within three-color mixed cullet used in the production of amber glass products, such as beer bottles.

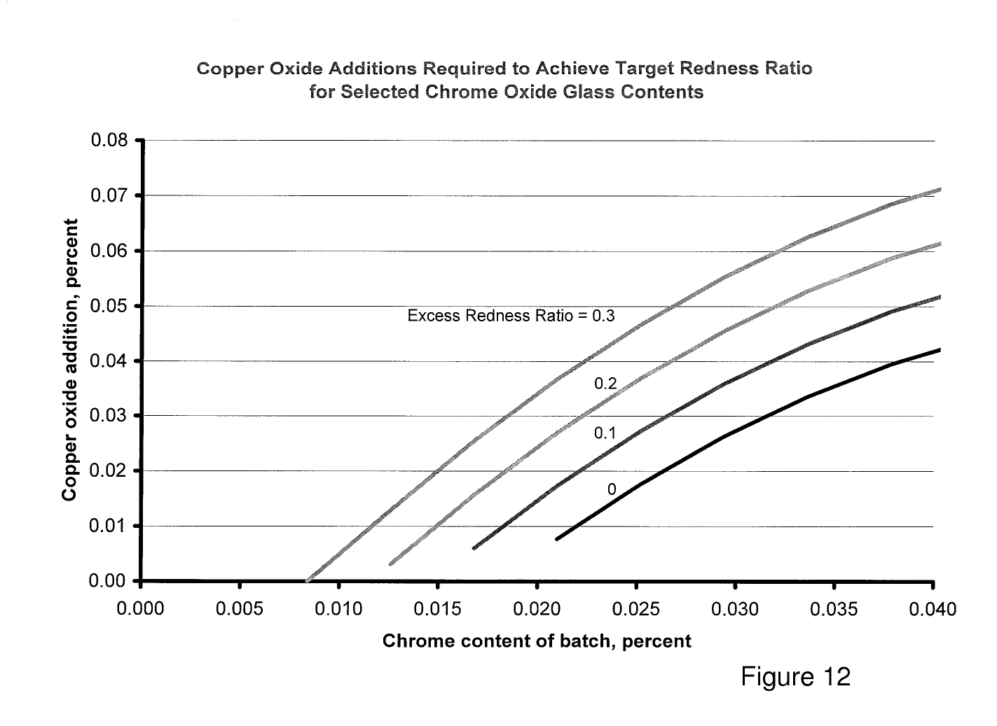

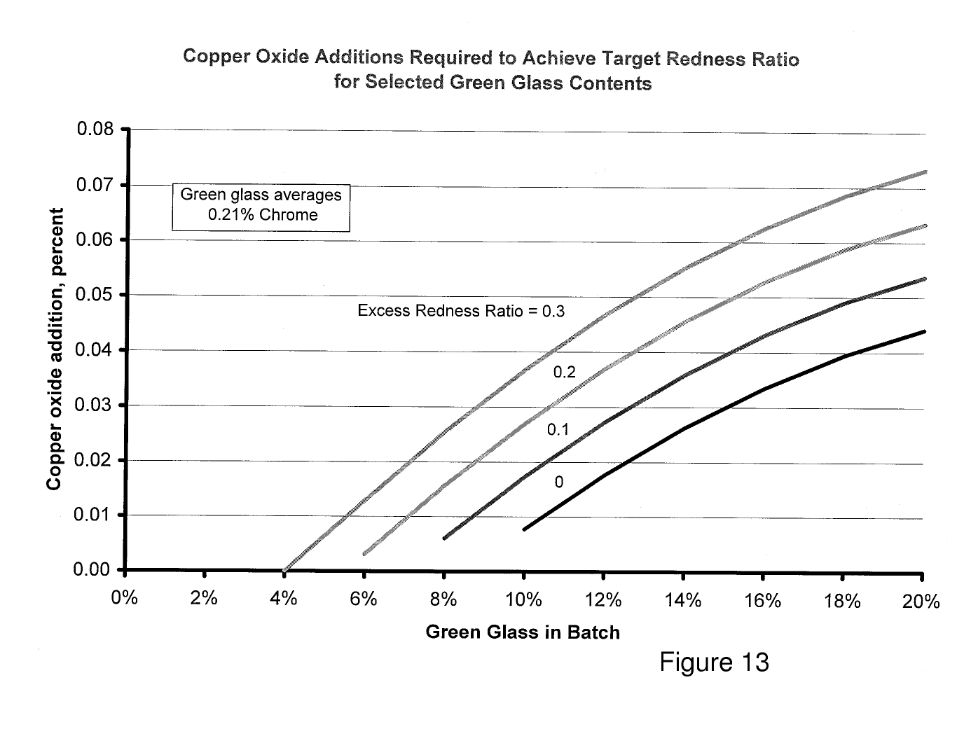

The following assumptions were made in developing the inverse prediction model described herein. First, an “excess” redness ratio (transmission at 650 nm/550 nm) is specified. This is the amount of redness ratio as defined by a target amber bottle specification in excess of the minimum specification for the commercial definition of amber glass (observed redness ratio minus minimum redness ratio according to the definition of amber glass). This parameter is required (rather than simply specifying the redness ratio) so that the analysis and formula is independent of the 550 nm transmission characteristics of the glass (and the 550 nm transmission has been found to be a moving target that is hard to control in laboratory melts). Sample curves for excess redness ratios of 0, 0.1, 0.2, and 0.3 are illustrated for different percentages of chrome in the glass batch and for green glass in the glass batch in FIGS. 12 and 13, respectively. Redox is hard to control exactly in lab melts, and 550 nm transmission is a strong function of redox. The solution was to use 550 nm transmission as a normalizing parameter that adjusts for variations in laboratory redox conditions. Second, the green glass is defined as containing 0.21% chrome oxide (Cr₂O₃). This enables the coloring effect of chrome oxide to be related to the green glass level in the batch. Naturally, there is a range of chrome contents in green glass and the 0.21% number is an average. Modifications should be made if extreme green glass containing higher or lower amounts of chrome oxide are encountered. Third, green glass content is always expressed as a percentage of the final melted glass. Thus, a glass that is melted from mixed color cullet containing 50% green glass and 50% amber glass in which the cullet level is 40%, contains 20% green glass. Accepting these assumptions, an inverse prediction model may be generated from the non-linear model for copper addition to glass batches containing green glass. This inverse prediction model allows the necessary amount of copper oxide to be computed by just knowing the amount of green glass in the final glass batch and the desired excess redness ratio.

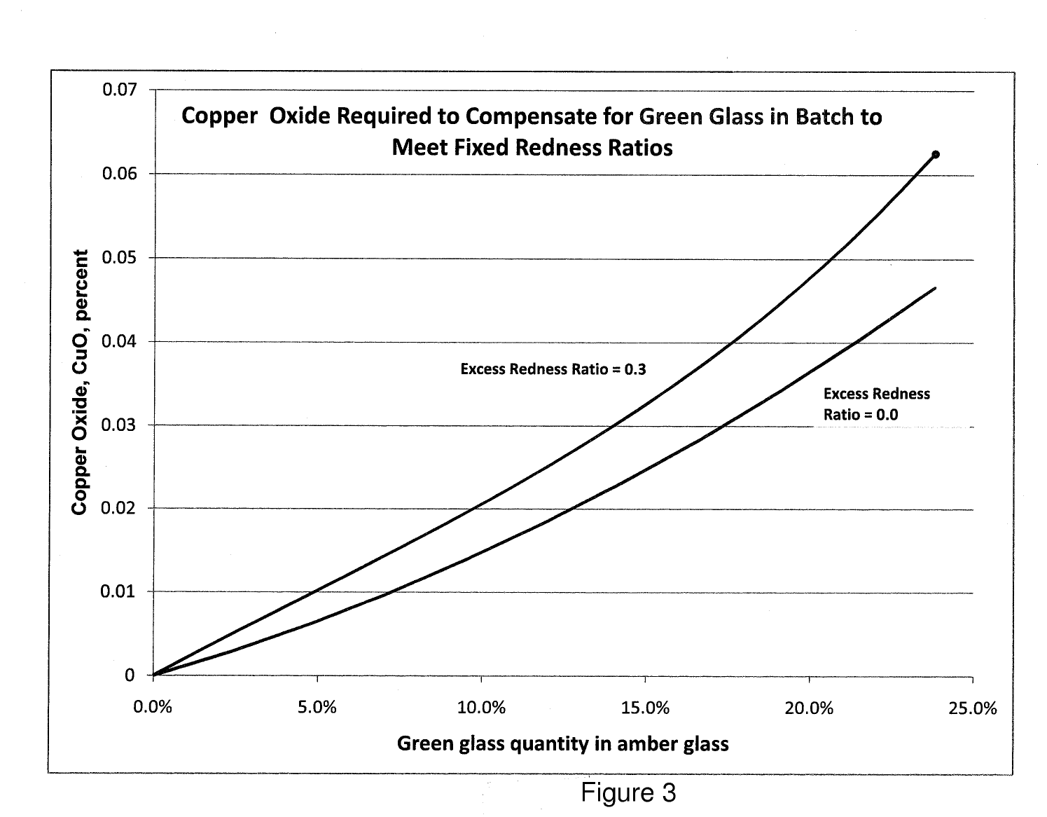

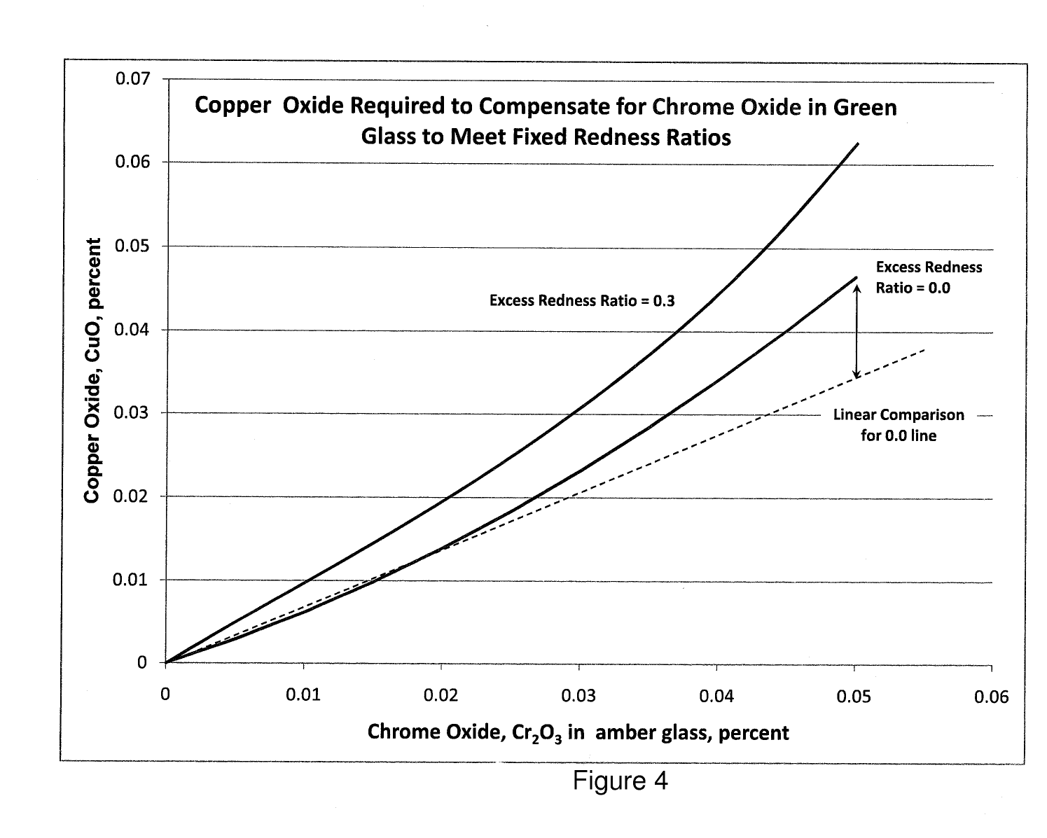

As shown in FIGS. 3 and 4, the relationship between copper oxide and the amount of green glass or chrome oxide is strongly nonlinear. FIG. 4 illustrates a linear line for demonstration to indicate the nonlinearity. The nonlinearity of the relationship between the total weight percent of green glass in the batch and the amount of color compensating copper oxide appears to arise from two sources. Firstly, as increasing increments of green glass are added to the amber glass batch, the amount of neutralized green glass increases, which consists of green and copper coloring agents together, giving a neutral gray component to the glass that gradually erodes the 550 nm transmission. Red coloration is required not only to color compensate the most recent increment of green glass, but also to provide reddish coloration to the previously compensated green glass increments. The first increments of green glass are weakly compensated to neutral gray since very small amounts of such a neutral gray will exist and the natural amber color of the vast majority of the glass masks this small amount of neutral gray. As the green glass increases in quantity, this hiding phenomenon is no longer effective and higher quantities of red colorant (copper oxide) are required to overcome the incremental green glass and also to provide redness to the growing fraction of neutral gray glass. Secondly, as the neutral gray fraction increases, the optical transmission of the glass at 550 nm, an important criterion in the definition of amber glass, begins to decrease. To compensate for this darkening of the glass, the redox of the glass must be made slightly less reducing (reduction in carbon) as the amount of chrome and copper is increased. This adjustment in the redox brings the 550 nm transmission back to within the proper range but also lowers the redness of the glass since the 650 nm transmission is also reduced. Thus, additional red colorant is required to maintain the 550 and 650 nm transmissions within the close tolerances required for amber glass as defined by commercial amber bottle users. The required change in redox is a slight change towards more oxidizing values to lighten the amber hue a small amount. This is necessary to maintain the 550 nm transmission at target values since the chrome/copper combination darkens the glass.

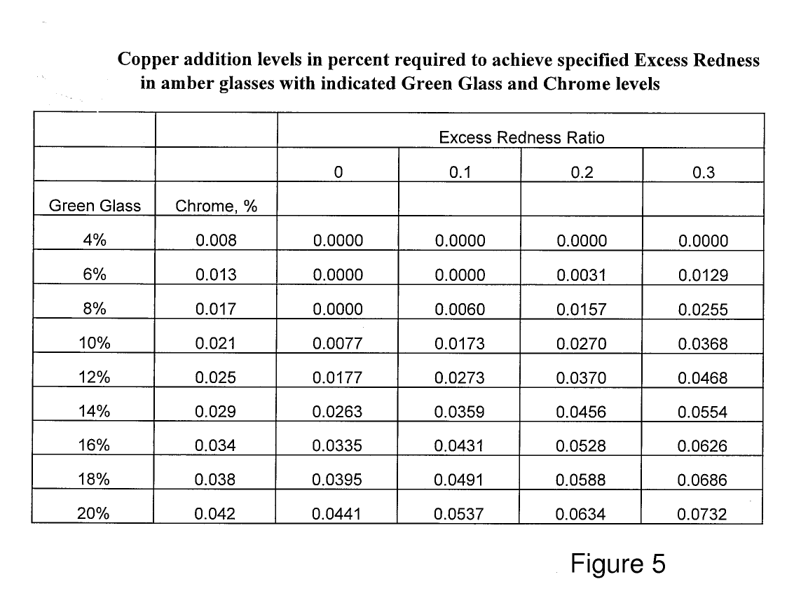

Certain aspects of the invention have been found especially suitable for decolorizing up to about 20% of green cullet; preferably from about 5% to about 15%, and still more preferably from about 8% to about 12% of green cullet. For example, an exemplary effective amount of copper oxide to at least partially neutralize the color effects of green glass in the manufacture of amber glass, and to retain a good redness ratio, may be determined according to FIG. 5 for excess redness ratios of 0, 0.1, 0.2, and 0.3, respectively.

Once mixing is complete, the blended raw materials, which include the effective amount of copper oxide, are fed from mixing stage 112 into melting stage 114, in which the raw materials are heated to between 1400 and 1600° C. and combine with each other, first in a solid state, then in a solid-liquid mixture, then in a complete liquid state. More specifically, within melting stage 114, a general sequence of events takes place as follows. First, melting of the solid raw materials occurs. Second, homogenization of the molten raw materials occurs. Third, refining of the molten raw materials occurs, i.e., bubbles are removed. Last, conditioning of the molten raw materials occurs, which is the process of cooling the molten raw materials to a uniform temperature, uniform chemical composition, and uniform homogeneity suitable for forming.

The molten raw materials then pass from melting stage 114 into bottle-forming stage 116 in which the end product is formed from the viscous liquid via the well-known glass blowing process, which is a process of inflating molten glass by means of a blowpipe, thereby forming the desired bottle shape. Once the amber bottles are formed, they pass from bottle-forming stage 116 to cooling/annealing stage 118 in which the amber bottles are allowed to cool at a slow, uniform rate, thereby removing stress within the glass.

Inspection stage 120 is the stage within glass manufacturing system 100 in which the end product is inspected to determine whether it meets the expected quality and color specifications. For example, a bottle-to-bottle inspection event takes place within inspection stage 120 to determine the mechanical integrity of the end product, i.e., an inspection for bubbles and cracks. Furthermore, a periodic inspection event takes place to determine whether the color specification is met by using a spectrophotometer to measure the percent transmission of the glass of each individual wavelength throughout the visible spectrum, i.e., about 400 to 700 nm wavelength. A spectrophotometer, which is generally understood to be a device that measures the amount of light absorption or transmission of a sample. A spectrophotometer is also more particularly known as a device that can measure intensity as a function of the color, or wavelength, of light. However, one of skill in the art would understand there to be many types of spectrophotometers, any number of which may be applicable to certain aspects of the present invention. Among the common distinctions used to classify them are the wavelengths they work with, the measurement techniques they use, how they acquire a spectrum, and the sources of intensity variation they are designed to measure. More specifically, a color characteristic known as “redness ratio” is measured using the spectrophotometer. The redness ratio is represented by:

$$redness ratio = \frac{\% transmission of 1 / 8 inch thick glass at 650 nm}{\% transmission of 1 / 8 inch thick glass at 550 nm}$$

The measured redness ratio is then compared against a predetermined redness ratio specification for the desired end product. For example, a typical acceptable redness ratio for amber glass that possesses a 550 nm transmission of 12% is greater than or equal to 2.0 (there is typically no upper limit, but only a lower limit). If the redness ratio falls below 2.0, the batch formulation may be adjusted to add more copper oxide to the mixture.

Once the inspection process within inspection stage 120 is complete, those bottles that pass inspection, typically 90-92%, are bulk-packed and shipped to the end user. Conversely, those bottles that fail inspection, typically 8-10%, are crushed, thereby forming cullet, and returned to raw materials supply 110.

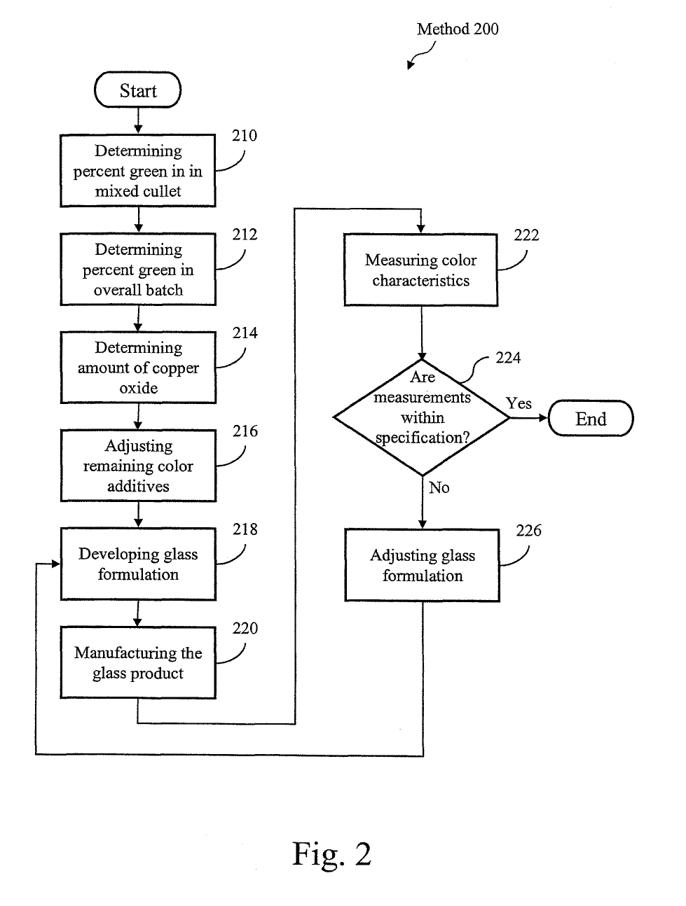

FIG. 2 illustrates a flow diagram of a method 200 of using copper oxide in accordance with the invention to neutralize green glass within three-color mixed cullet, which is used in the production of amber glass products. Method 200 includes the steps of:

Step 210—Determining Percent Green in Mixed Cullet:

In this step, the percent green in the mixed cullet within raw materials supply 110 of glass manufacturing system 100 is determined by, for example, a technician manually measuring the weight fractions of each of the three colors, i.e., flint, amber, and green. This variable is supplied to batch controller 122. Method 200 proceeds to step 212. Still further, the percent of green glass in the cullet may be determined by any number of methods such as those techniques as described in U.S. Pat. No. 7,383,695 and U.S. Pat. No. 7,386,997, both of which are herein incorporated by reference.

Step 212—Determining Percent Green in Overall Batch:

In this step, the percent green in the overall batch is determined by multiplying the percent mixed cullet in the batch by the percent green in the mixed cullet. For example if 40% mixed cullet is being charged to the manufacturing process and the three-color mixed cullet further includes 22% green, 30% amber, and 48% flint as determined in method step 210, batch controller 122 calculates the percent green within the total mixture to be 8.8%. Method 200 proceeds to step 214.

Step 214—Determining Amount of Copper Oxide:

In this step, the amount of copper oxide required in the glass formulation to neutralize the percent green determined in step 212 is set according to nonlinear relationship between the effective amount of copper oxide and the amount of green glass present in the mixed-color cullet. Method 200 proceeds to step 216.

Step 216—Adjusting Remaining Color Additives:

In this step, the amount of copper oxide determined in step 214 is applied to the model used for batch calculation, which calculates the proper amount of all raw materials. Because of the addition of copper oxide needed to neutralize the green color, both the 550 nm and 650 nm transmission are affected; thus, the lightness/darkness characteristic needs to be considered. As a result, the base amber color must be lightened via redox control to make the glass somewhat more oxidizing. Method 200 proceeds to step 218.

Step 218—Developing Glass Formulation:

In this step, based upon the determination of the amount of copper oxide and other color additives required in the glass formulation, the overall glass formulation for use within manufacturing system 100 is developed, either manually or automatically, by batch controller 122. Method 200 proceeds to step 220. As will be appreciated by those skilled in the art, such a glass formulation may be developed to at least partially decolorize green glass cullet in the production of amber or flint glass. For flint glass, since it is not possible to “bleach” the colored glass cullet one must simply minimize their impact. This may be done by at least partially decolorizing the green glass cullet constituents with the addition of copper oxide, and further compensating for the remaining colored cullet constituents, likely amber cullet, with the addition of cobalt (blue) and selenium (red) to give a neutral density absorption, i.e., a “colorless” glass. Thus, the key indicators for clear (flint) glass formulation will likely be the addition of effective amounts of copper oxide, selenium and cobalt, among other process variables.

Step 220—Manufacturing the Glass Product:

In this step, under the control of batch controller 122, the glass product is manufactured via glass manufacturing system 100, as described in FIG. 1. More specifically, the glass product is manufactured using raw materials from raw materials supply 110, according to the glass formulation of step 218. These raw materials subsequently feed into mixing stage 112, in which they are blended. Subsequently, the blended raw materials are fed into melting stage 114, in which the raw materials combine with each other, first in a solid state, then in a solid-liquid mixture, then in a complete liquid state at typically between 1400° C. and 1600° C. Subsequently, the molten raw materials are fed into bottle-forming stage 116, in which the end product is formed from the viscous liquid via the well-known glass blowing process. Subsequently, the amber glass product passes into cooling/annealing stage 118, in which the amber glass product is allowed to cool at a slow, uniform rate, thereby removing stress within the glass. Finally, the amber glass product passes into inspection stage 120. Method 200 proceeds to step 222.

Step 222—Measuring Color Characteristics:

In this step, using a spectrophotometer within inspection stage 120, the color characteristics of the end product are measured to determine whether they meet the expected color specifications. More specifically, the redness ratio is measured using the spectrophotometer and calculated according to:

$$redness ratio = \frac{\% transmission of 1 / 8 inch thick glass at 650 nm}{\% transmission of 1 / 8 inch thick glass at 550 nm}$$

Furthermore, the lightness/darkness characteristic is assessed via the 550 nm measurement. Method 200 proceeds to step 224.

Step 224: Are Measurements within Specification:

In this step, using feedback from the color measurements of step 222 it is determined whether the color characteristics and lightness/darkness characteristic meet the end product specifications. This is accomplished by batch controller 122, which compares the measured redness ratio lightness/darkness characteristic with the predetermined specifications for the end product. A typical acceptable redness ratio for amber glass is greater than or equal to 2.0. In this example, if the redness ratio falls below 2.0, the batch formulation may be adjusted to add more copper oxide to the mixture. Thus, transmission characteristics and especially the redness ratio may be used as quality control metrics in determining whether a product falls within a desired specification. If all color characteristics are within specification, method 200 ends. If any color characteristic is not within specification, method 200 proceeds to step 226.

Step 226—Adjusting Glass Formulation:

In this step, the glass formulation is adjusted in a manner that will bring the color specifications of the end product within acceptable levels. For example, the amount of copper oxide may be adjusted and/or the base amber color may be lightened via redox control. Method 200 returns to step 218.

### EXAMPLES

Certain aspects the present inventions will be described below in detail. Unless, otherwise noted all percentages are weight percent. It will be appreciated by one of ordinary skill in the art that the descriptions given herein with those figures and methods of recycling mixed color cullet are for exemplary purposes only and is not intended to limit the scope of the invention in any way.

### Example 1

Earlier investigative efforts indicated that about 17 ppm CuO per percent of green glass in a batch was effect in decolorizing up to about 8% green cullet. Thus, 136 ppm (0.0136%) of copper oxide would be an effective amount to at least partially decolorize about 8% green glass cullet content. More recently, higher levels of green glass have been successfully incorporated into amber glass making batches. However, accommodating these higher green glass amounts required an increasingly and disproportionately higher amount of CuO to achieve near the same redness.

Further work was done to explore the apparent non-linear relationship between green glass level, copper oxide additions, and redness ratio. In this example, 550 g soda lime glass batches were melted at 1500° C. in an electric furnace having ambient atmosphere. Glass compositions were prepared over a range of green glass levels corresponding to various chrome oxide (Cr₂O₃) levels in the glass as shown in the Table 1. Approximately 0.017% to about 0.042% chrome oxide (Cr₂O₃) was directly added to a 550 g batch to simulate the green color corresponding to about 8%, about 14%, and about 20% green glass cullet content. This concentration range was thought to adequately cover the various green hues found in most commercially encountered glass compositions such as dark smoky greens found in Champagne bottles to bright emerald greens generally characterized by the HEINEKEN® bottle, to light green glass found in Chardonnay bottles.

Copper oxide (CuO) was added as a ratio of the simulated green glass cullet content. Again, as shown in Table 1, copper oxide was added as 15, 21, and 34 ppm per percentage of green glass content. Initial experiments, previously discussed, showed favorable decolorizing was obtained using 17 ppm CuO per percentage of green glass content up to about 8% of green glass content. Thus, twelve (12) glass melts were made in accordance with the experimental matrix of Table 2 to investigate the non-linear relationship between green glass content, copper oxide additions, and redness ratio.

TABLE 1
Target Weight Percentage of Copper Oxide Based upon Green Glass
Content.

| | | Corresponding | | | | |
|---|---|---|---|---|---|---|
| | Amount | simulated green | Target Copper Oxide Addition | | | |
| | of chrome | glass cullet | (ppm CuO per % Green Glass) | | | |
| | oxide | content | 0 | 15 | 21 | 34 |
| Low | 0.0168% | 8% | 0.0000% | 0.0120% | 0.0168% | 0.0272% |
| Medium | 0.0294% | 14% | 0.0000% | 0.0210% | 0.0294% | 0.0476% |
| High | 0.0420% | 20% | 0.0000% | 0.0300% | 0.0420% | 0.0680% |

TABLE 2
Redness Ratio After Copper Oxide Addition

| | | % Copper | | |
|---|---|---|---|---|
| | % Chrome | Oxide | Redness | Excess |
| Composition | Oxide | Addition | Ratio | Redness |
| 1 | 0.0168 | 0.0168 | 2.15 | 0.180 |
| 1 | 0.0168 | 0.0168 | 2.34 | 0.320 |
| 2 | 0.0168 | 0.0272 | 2.15 | 0.390 |
| 2 | 0.0168 | 0.0272 | 2.44 | 0.380 |
| 2 | 0.0168 | 0.0272 | 2.26 | 0.340 |
| 3 | 0.0294 | 0.0294 | 2.28 | 0.170 |
| 3 | 0.0294 | 0.0294 | 2.04 | 0.070 |
| 3 | 0.0294 | 0.0294 | 2.10 | 0.120 |
| 4 | 0.0294 | 0.0476 | 2.30 | 0.110 |
| 4 | 0.0294 | 0.0476 | 2.32 | 0.170 |
| 4 | 0.0294 | 0.0476 | 2.18 | 0.140 |
| 5 | 0.0420 | 0.0420 | 2.12 | −0.015 |
| 5 | 0.0420 | 0.0420 | 1.97 | −0.065 |
| 6 | 0.0420 | 0.0680 | 1.96 | 0.015 |
| 6 | 0.0420 | 0.0680 | 2.15 | −0.055 |
| 7 | 0.0168 | 0.0120 | 2.20 | 0.140 |
| 7 | 0.0168 | 0.0120 | 2.28 | 0.220 |
| 8 | 0.0294 | 0.0210 | 2.15 | 0.060 |
| 9 | 0.0420 | 0.0300 | 2.04 | 0.000 |
| 9 | 0.0420 | 0.0300 | 1.72 | −0.140 |
| 10 | 0.0168 | 0.0000 | 1.93 | −0.090 |
| 10 | 0.0168 | 0.0000 | 2.03 | 0.100 |
| 11 | 0.0294 | 0.0000 | 1.44 | −0.270 |
| 11 | 0.0294 | 0.0000 | 1.73 | −0.340 |
| 12 | 0.0420 | 0.0000 | 1.57 | −0.400 |
| 12 | 0.0420 | 0.0000 | 1.38 | −0.620 |

Data from the 12 compositions are shown in Table 2 and include the transmission data normalized to a constant thickness of 3.18 mm (⅛ inch). The redness ratio is defined as the ratio of the transmission at 650 nm to the transmission at 550 nm for a sample of 3.18 mm thickness. Melting redox sensitive glasses in the laboratory is a difficult activity since the ambient atmosphere of the furnace tends to alter the redox state of the small quantity of glass melted in such experiments. Significant random fluctuations in redox state are observed under these experimental conditions. To account for these random variations the “excess redness ratio” experimental response was used. The excess redness ratio is defined as the difference between the measured redness ratio of the melted glass and the minimum threshold redness ratio defined by commercial specifications for a glass with the same 550 nm transmission as the melted glass. Thus, although redox variability in the melts generated variance in the 550 nm transmission of replicated melts, the relative redness as measured by the “excess redness ratio” accurately portrayed the ability of copper additions to offset green glass content.

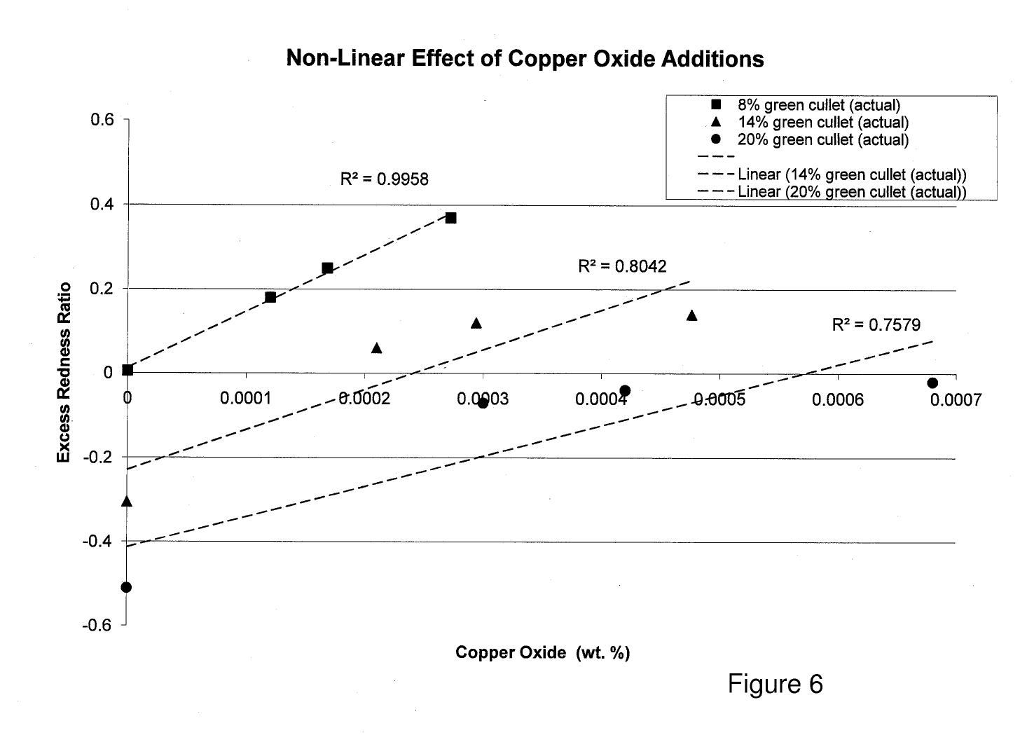

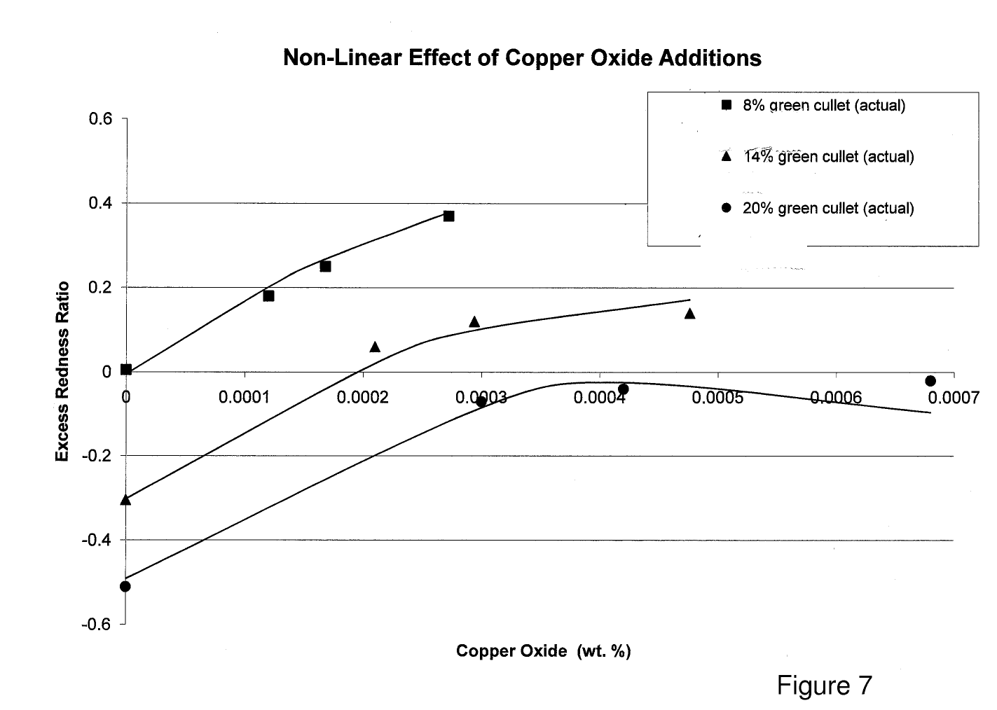

Statistical regression analysis was performed to determine the relationship between the effect of copper oxide additions and the green glass content of the cullet, as represented by the Cr₂O₃ level, on the redness ratio of amber glass. Particularly, excess redness was determined as a function of the simulated green glass content (i.e., chrome oxide addition) and the amount of copper oxide. As shown in FIG. 6, a linear regression model for each data set exhibited high R² value at low amounts of simulated green glass but deteriorated as simulated green glass content increases. Nonetheless, a linear regression model for all 24 data points (not shown), exhibited an R² value of 0.84, a modestly good degree of fit. The intercept of the linear model was 0.438, indicating good redness when neither chrome nor copper are present, and the coefficients for chrome and copper were −21.6 and 8.92 respectively. While the absolute value R² value appeared generally acceptable, further analysis showed that the residual values were non-randomized thus evidencing the true insufficiency of the model fit. FIG. 7, however, depicts a more preferred non-linear model including quadratic terms for both copper and chrome additions to better represent the non-linear effect of copper oxide on excess redness ratio. The results of the non-linear model show an improved R² factor of 0.95 for all 24 data points, a relatively excellent degree of fit having acceptable residual values. Thus, such non-linear characterization was the preferred data analysis method.

Y=−21.6(Cr₂O₃)+8.92(CuO)+0.438 LINEAR_EQUATION:

Y=X₀+CO*GG*X_{C1}+(0.0021*GG)²*X_{C2}+XS*X_{X1}+XS²*X_{X2} NON_LINEAR_EQUATION:

where:

Y is the amount of copper oxide, as a percent of total glass weight, added to produce an excess redness ratio (XS) of given value when the green glass content, as a percent of total glass weight, is GG;

CO is the amount of chrome oxide, as a percent of total glass weight, as a percent of total glass weight;

GG is the green glass content of the batch of glass expressed as a percentage of total glass weight;

XS is the desired excess redness ratio of the melted glass defined as the difference between the measured redness ratio (T650/T550) and the amber glass minimum acceptable redness ratio as defined by a target amber glass specification;

X₀ is an intercept with a Y axis;

X_{C1} is a chrome linear value;

X_{C2} is a chrome quadratic value;

X_{X1} is a redness ratio linear value; and

X_{X2} is an excess redness quadratic value.

In an exemplary embodiment, X₀=−0.0623, X_{C1}=4.127, X_{C2}=−38.04, X_{X1}=0.0955, and X_{X2}=0.00496.

The experimental excess redness data as well as the model predicted values and the residuals (actual minus predicted) are given in Table 3. Note the good fit between the excess red and predicted excess red columns as revealed by the small absolute value of the residuals in the right-most column. These values, the actual data points and the predictive lines, are graphed in FIG. 7, each data set representing the effect of copper oxide additions to glasses containing a varying amounts of simulated green glass (chrome oxide additions) as noted in the figure. Interestingly, for 20% green glass content, the model showed a slight decrease where the actual data implies a leveling off after about 0.0004 copper oxide. One skilled in the art would nonetheless understand that any number of non-linear equations, having an acceptable variance (R²), may be used to fit the presented data without departing from the scope of the invention. One skilled in the art would further understand that even a linear equation could be used to fit the following data while exhibiting an acceptable R² value without departing from the teachings and scope of the present invention.

TABLE 3
Comparison of actual and predicted redness ratio

| | | Simulated | | | Predicted | |
|---|---|---|---|---|---|---|
| | | Green | Copper | Excess | Excess | |
| | Chrome Oxide | Glass | Oxide | Redness | Redness | |
| Composition | Content | Content | Addition | Ratio | Ratio | Residual |
| 10 | 0.0168% | 8% | 0.0000% | 0.0050 | −0.0046 | 0.0096 |
| 7 | 0.0168% | 8% | 0.0120% | 0.1800 | 0.2018 | −0.0218 |
| 1 | 0.0168% | 8% | 0.0168% | 0.2500 | 0.2680 | −0.0180 |
| 2 | 0.0168% | 8% | 0.0272% | 0.3700 | 0.3792 | −0.0092 |
| 11 | 0.0294% | 14% | 0.0000% | −0.3050 | −0.3023 | −0.0027 |
| 8 | 0.0294% | 14% | 0.0210% | 0.0600 | 0.0205 | 0.0395 |
| 3 | 0.0294% | 14% | 0.0294% | 0.1200 | 0.0994 | 0.0206 |
| 4 | 0.0294% | 14% | 0.0476% | 0.1400 | 0.1719 | −0.0319 |
| 12 | 0.0420% | 20% | 0.0000% | −0.5100 | −0.4908 | −0.0192 |
| 9 | 0.0420% | 20% | 0.0300% | −0.0700 | −0.0845 | 0.0145 |
| 5 | 0.0420% | 20% | 0.0420% | −0.0400 | −0.0245 | −0.0155 |
| 6 | 0.0420% | 20% | 0.0680% | −0.0200 | −0.0954 | 0.0754 |

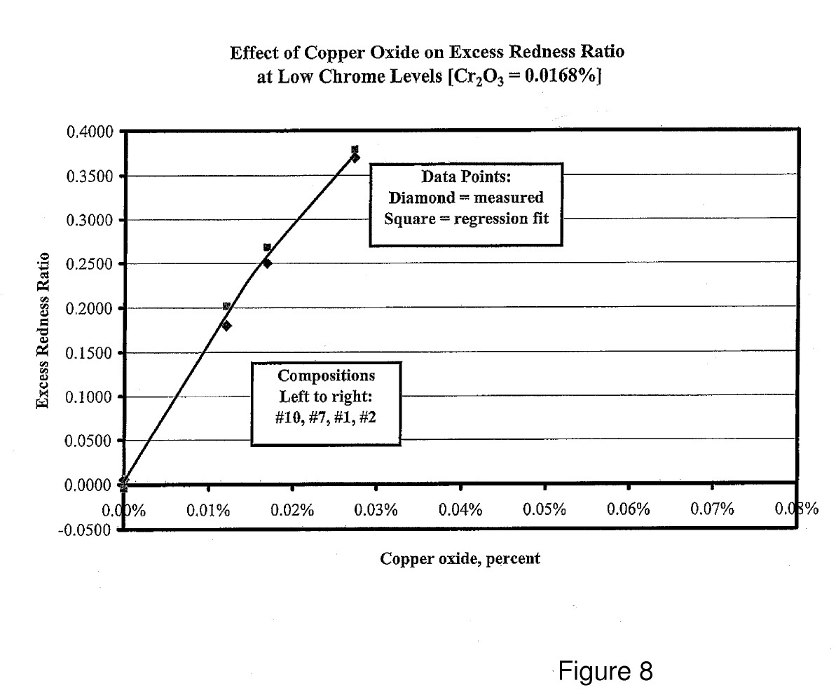

FIG. 8 shows the actual and quadratic predicted values for a Cr₂O₃ concentration of 0.0168%, which corresponds to about 8% green glass content. Here, the composition responds quickly and nearly linearly to copper oxide additions to attain desired redness ratio. The copper oxide levels are shown on the abscissa in absolute percentages, and correspond to 0, 15, 21, and 34 ppm CuO per percentage of green glass content as previously noted. In prior work, approximately 17 ppm CuO per percentage of green glass content had been shown to adequately restore the redness ratio with low green glass levels similar to the about 8% level of this figure. The restoration of the redness ratio to 0.2 units above the redness ratio threshold, i.e. excess redness ratio of 0.2, is consistent with this prior experience.

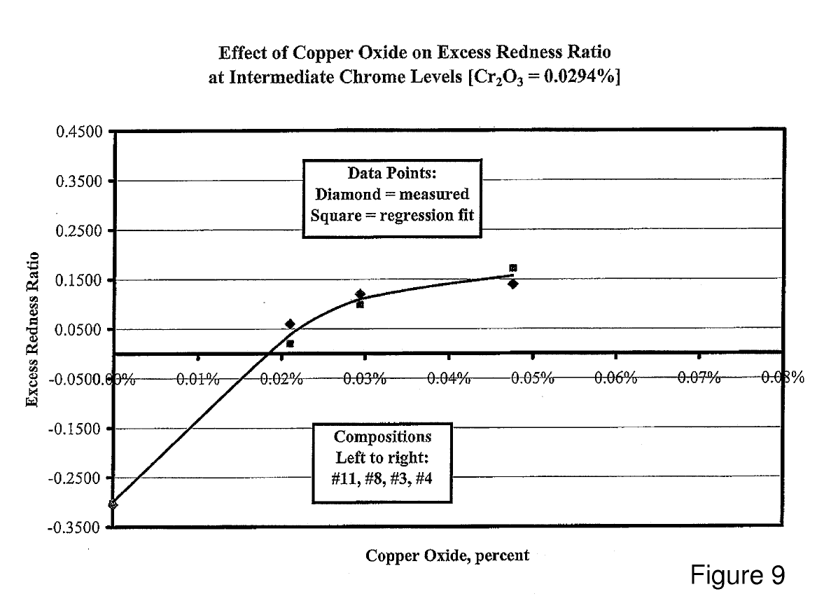

FIG. 9 shows a somewhat similar, but decidedly non-linear, effect for a Cr₂O₃ concentration of 0.0294% corresponding to 14% green glass. Here, the excess redness ratio intercept is much lower, about −0.30 excess red, indicative of high levels of higher levels of green glass in the melt and decidedly poor initial redness. As shown, copper oxide does restore redness, although the initial response is lower than that experienced at lower green glass amounts. Without being limited by theory, this phenomenon may be expected since a certain degree of spectral neutral coloration of the glass may occur as the chrome and copper color centers combine.

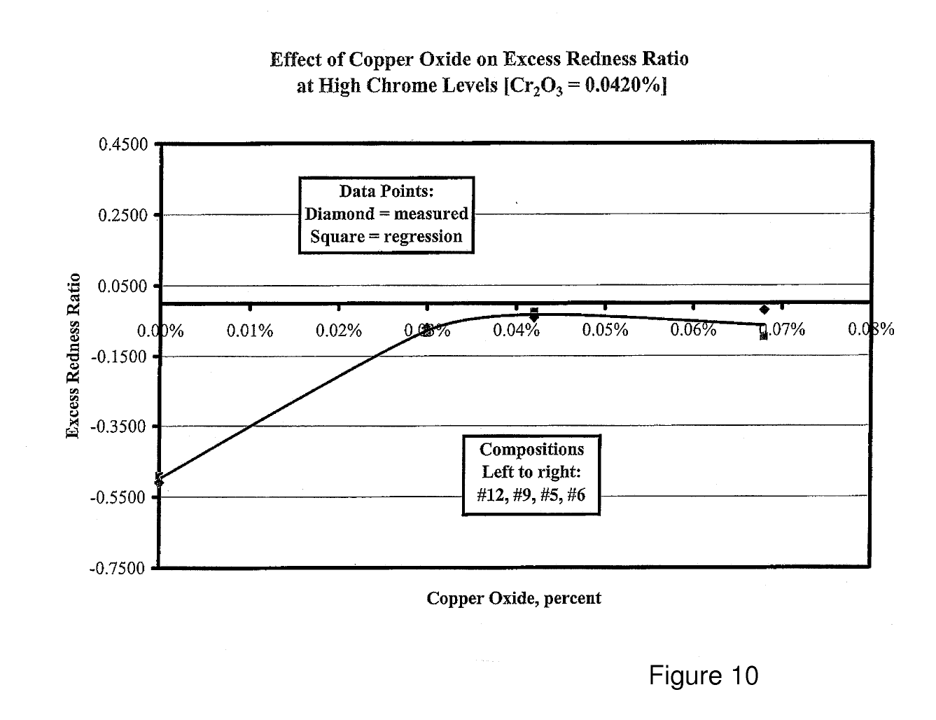

FIG. 10 shows the behavior for a Cr₂O₃ concentration of 0.0420% corresponding to 20% green glass. Here again, the intercept and the slope of the line are reduced even further due to the increased levels of simulated green glass, i.e., chrome oxide. Nonetheless, as higher levels of copper oxide are added to the composition melts near threshold redness ratios are attained. Although, even a visual inspection shows the evident departure from linearity.

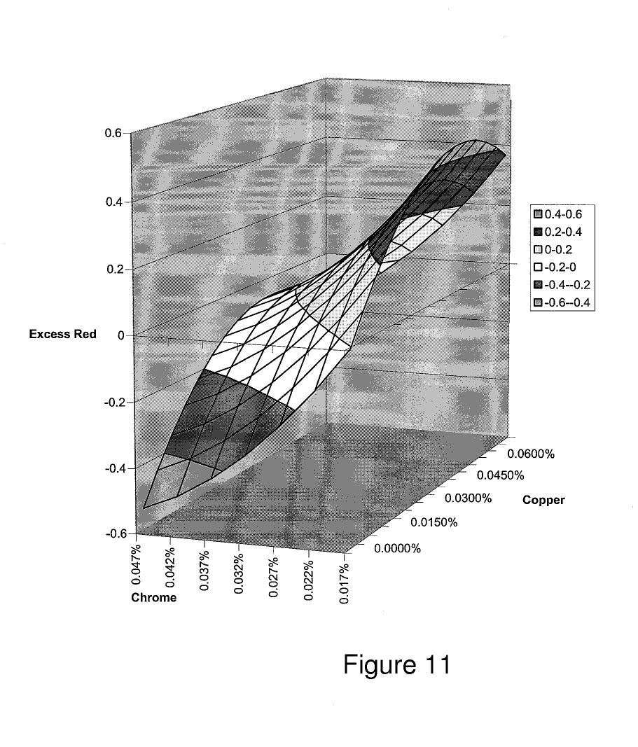

FIG. 11 depicts a response surface of excess redness ratio versus both copper oxide and chrome oxide addition levels. Using this figure, various recipes of chrome and copper additions may be determined. For example, beginning at 0.0168% Cr₂O₃ (about 8% green glass) where the excess redness is just slightly negative, the curve drops sharply with additional chrome to very low excess redness ratios. Copper additions, on the other hand, result in a restoration of the excess redness, indeed the slope of this restoration depends on the chrome and the copper level in a decidedly non-linear way.

Copper oxide was effective at all simulated green glass levels in increasing the redness ratio of the resultant glass. Nonetheless, there is a preferable non-linear relationship between the simulated green glass content and an effective amount of copper oxide. At low simulated green glass levels (about 8%) copper oxide is highly effective at increasing redness as evidenced by a steep positive slope to the redness ratio curve. At higher constant levels of green glass, the effectiveness of copper oxide appears to be somewhat inversely proportional to the amount of its addition. Without being limited by theory, this may reflect a saturation effect of the colloidal copper red color centers, or it may simply be a colorimetric effect in which the strong presence of green color centers inhibits the increasing of redness ratio regardless of the copper oxide content.

In summary, method 200 of the present invention uses copper oxide within the conventional glass manufacturing process, such as described with reference to glass manufacturing system 100, to neutralize the color effects of high levels of green glass within mixed cullet used in the production of amber glass products, such as beer bottles. Furthermore, and as illustrated in FIG. 3, method 200 preferred aspects of the present invention demonstrate a nonlinear relationship between the weight percent green in the mixture and the amount of copper oxide required to neutralize the green glass in the production of amber glass products. Last, by using copper oxide as a specific remedy for high-percentage green glass levels, method 200 of the now allows the use of entire amounts of mixed cullet in glass manufacture that previously could not have been used, thereby imparting greater market value to green glass for use in making amber glass.

The data presented above shows how redness ratio varies quadratically with various levels of chrome and copper. However, what technicians really want to know is the quantity of copper oxide that is required by a certain amount of green cullet in an amber batch in order to restore a desired amber color. In this regard, the following regression equations based on the above data will provide the required copper oxide content based on the amount of green glass in the batch.

In the following example, it is assumed that the green glass contains 0.21% Cr₂O₃. The relationships are as follows for two levels of Excess Redness Ratio [XSRR=0 and XSRR=0.3] where GG indicates percent green glass:

For XSRR=0.0

CuO, %=0.00113*GG+0.00348*GG²

For XSRR=0.3

CuO, %=0.00169*GG+0.00357*GG²

Calculated values based on these relationships is provided in Table 4 below:

TABLE 4
Copper Oxide [CuO] required to generate XSRR of 0 and 0.3.

| | | |
|---|---|---|
| | | Copper Oxide Addition |
| | | (ppm CuO per % Green |
| Green | Chrome | Glass) |

| Glass | Oxide | XSRR = 0 | XSRR = 0.3 |
|---|---|---|---|
| 0 | 0.0000% | 0.00000% | 0.00000% |
| 3.00% | 0.0063% | 0.00370% | 0.00539% |
| 6.00% | 0.0126% | 0.00803% | 0.01143% |
| 9.00% | 0.0189% | 0.01298% | 0.01811% |
| 12.00% | 0.0252% | 0.01856% | 0.02544% |
| 15.00% | 0.0315% | 0.02477% | 0.03340% |
| 18.00% | 0.0378% | 0.03160% | 0.04201% |

FIG. 3 illustrates the amount of copper oxide from Table 4 required to compensate for green glass in the amber batch to meet fixed redness ratios, while FIG. 4 illustrates the amount of copper oxide from Table 4 required to compensate for chrome oxide in green glass to meet the fixed redness ratios.

### Example 2

### Crucible Melted Glass

An amber glass batch was prepared from the following raw materials with an amount of Cr₂O₃ sufficient to simulate the incorporation of 14% green glass (at 0.21% Cr₂O₃) in the batch on a melted glass basis.

| Material | grams | Percent |
|---|---|---|
| Sand, Glassil 510 | 318.6 | 57.89% |
| Aragonite | 62.30 | 11.32% |
| Nepheline Syenite | 18.61 | 3.38% |
| Slag, Calumite | 37.52 | 6.82% |
| Melite 40 | 7.456 | 1.35% |
| Soda Ash | 105.5 | 19.17% |
| Carbocite #20 | 0.033 | 0.0060% |
| Chrome Oxide | 0.1402 | 0.0255% |
| Copper Oxide | 0.2275 | 0.0413% |
| Totals | 550.3867 | |

This batch has a loss on ignition of 13.3%. Thus, the 550 grams of batch produced 477 g of melted glass. This 477 g of glass contained 0.1402 g of Cr₂O₃, or 0.0294%, which corresponds to 14% green glass. 0.2275 g of copper oxide (CuO) was added to the melt to compensate for the greenness of the Cr₂O₃. The batch contained sulfur in various forms in an amount equivalent to four pounds of SO₂/ton of glass and the batch redox number was −40. The batch was melted in a fused silica crucible over a four hour period in an electric furnace with ambient atmosphere. After melting, patties were cast and annealed at 1° C./minute through the annealing range followed by slow cooling to room temperature. Specimens were cut and polished from the patties for transmission requirements. A Perkin Elmer Lambda 9 spectrophotometer was used to collect transmission data in the range of 400-1000 nm.

This high amount of green glass in an amber composition substantially degrades the redness ratio of the amber glass unless compensating colorants are used. The uncompensated redness ratio for this glass without the copper oxide is 1.73, well below the minimum redness ratio of 2.07 for the glass. However, the above formula with 0.2275 g of copper oxide produced a glass with a redness ratio of 2.32, a 550 nm transmission of 7.07% (3.18 mm section) and a 650 nm transmission of 16.4%. The minimum redness ratio according to commercial specifications for the glass is 2.15. Hence, the glass exhibits an excess redness ratio of +0.17.

### Example 3

### Commercial Scale Melting of Amber Glass

Amber glass was melted in a small commercial melter at the rate of approximately 15 tons/day. The following batch composition was used:

| | Cullet weight, | Total Batch | |
|---|---|---|---|
| Material | lbs. | weight, lbs. | Percent |
| Post consumer cullet: | | | |
| Clear | 376 | | |
| Amber | 232 | | |
| Green | 192 | | |
| Total post consumer cullet | 800 | 800 | 37.14% |
| Internal return cullet | | 200 | 9.28% |
| Virgin raw materials: | | | |
| Sand, Glassil 510 | | 649.2 | 30.14% |
| Aragonite | | 113.9 | 5.29% |
| Nepheline Syenite | | 16.5 | 0.76% |
| Slag | | 109.9 | 5.10% |
| Gypsum | | 3.4 | 0.16% |
| Melite 40 WVA | | 25.5 | 1.18% |
| Soda Ash | | 234.7 | 10.90% |
| Carbocite #20 | | 1.085 | 0.05% |
| Copper Oxide | | 0.263 | 0.01% |
| Totals | | 2154.4 | 100.01% |

| After Melting | Pounds |
|---|---|
| Glass | 2000.0 |
| LOI | 154.2 |
| Total | 2154.2 |
| Tons Glass | 1.0 |

The redox state of this glass could be well controlled because of the large quantity of glass and the steady-state operation of the tank. The melted glass contained 9.6% green glass and contained 132 ppm of copper oxide (CuO). The batch sulfur content equivalent was five pounds of SO₂ per ton of glass and the redox number was tuned to −53.6 to provide a stable 550 nm transmission at 8% (3.12 mm section).

Samples of glass were collected from the gob feeder above the inspection stage machine and pressed manually to a thickness in the range of 2-4 mm, which was sufficiently thin to enable spectrophotometer measurements of the light transmission values. The specimens were annealed and cut to a convenient size for measurement. Transmission measurements were made on a dual beam spectrometer in the wavelength range 400-1000 nm. The redness ratio was 2.32, well above the 2.11 minimum definition of commercial amber glass for this 550 nm transmission level. This redness ratio exceeds that expected for the indicated copper addition level based on crucible melts and points to the different offset (tuning factors) needed for commercial furnaces compared to laboratory melts.

The invention having been disclosed in connection with the foregoing variations and examples, additional variations will now be apparent to persons skilled in the art. For example, this technique is not limited to the production of amber colored glass from mixed colored cullet. It may also be directed to the production of flint glass from mixed colored cutlet as well. For flint glass, a batch may be mixed with an effective amount of copper oxide to at least partially decolorize the resultant green glass cullet content. Other chemical or physical decolorizing agents, such as, oxides of cerium and zinc or selenium and cobalt may be used to neutralize any other remaining colored cullet content to achieve the desired degree of “colorless” flint glass.

The invention is not intended to be limited to the variations and examples specifically mentioned, and accordingly reference should be made to the appended claims to assess the spirit and scope of the invention in which exclusive rights are claimed.

What is claimed:

1. A method of recycling mixed color cullet comprising the steps of:
providing a glass cullet supply comprising green glass;
determining the weight percent of green glass in said glass cullet supply; and
determining an effective amount of copper oxide to, at least partially, decolorize said green glass wherein said effective amount is determined according to a non-linear relationship between at least said weight percent of green glass and said copper oxide.

2. The method of claim 1, wherein said green glass comprises at least one of Cr₂O₃ and Fe₂O₃.

3. The method of claim 1, wherein said glass cullet supply comprises up to about 25% by weight of green glass.

4. The method of claim 1, wherein said glass cullet supply comprises from about 5% to about 20% by weight of green glass.

5. The method of claim 1, wherein said glass cullet further comprises at least one of amber cullet and flint cullet.

6. The method of claim 1 wherein said non-linear relationship is in accordance with the following polynomial equation:
Y=X₀+CO*GG*X_{C1}+(0.0021*GG)²*X_{C2}+XS*X_{X1}+XS²*X_{X2}
where:
Y is the amount of copper oxide, as a percent of total glass weight, added to produce an excess redness ratio XS of given value when the green glass content, as a percent of total glass weight, is GG;
CO is the amount of chrome oxide, as a percent of total glass weight, as a percent of total glass weight;
GG is the green glass content of the batch of glass expressed as a percentage of total glass weight;
XS is the desired excess redness ratio of the melted glass defined as the difference between a measured redness ratio (T650/T550) and an amber glass minimum acceptable redness ratio as defined by a target amber glass specification;
X₀ is an intercept with a Y axis;
X_{C1} is a chrome linear value;
X_{C2} is a chrome quadratic value;
X_{X1} is a redness ratio linear value; and
X_{X2} is an excess redness quadratic value.

7. The method of claim 1, further comprising making a redox less reducing to maintain a glass batch produced from said method within a designated 550 nm transmission requirement as the amount of chrome and copper oxide is increased in the glass batch.

8. The method of claim 1 wherein said step of determining the amount of green glass in said glass cullet supply comprises the step of determining the weight percent of constituents of a sample of said glass cullet supply.

9. The method of claim 1 further comprising the steps of:
specifying prior to melting of said glass supply, transmission properties of desired resultant glass products;
calculating the desired amount of additional color modifiers;
developing a desired glass formulation having said effective amount of copper oxide; and
creating at least one recycled glass product according to said glass formulation.

10. A method as in claim 9, wherein the step of specifying transmission properties of said recycled glass products comprises the steps of specifying a thickness of a recycled glass product made from said determined glass formulation and specifying at least two of: an optical transmission of said recycled glass product at 550 nm (T₅₅₀), an optical transmission of said recycled glass product at 650 nm (T₆₅₀), and a redness ratio (T₆₅₀/T₅₅₀) of said recycled glass product.

11. The method of claim 9, further comprising the steps of:
determining a redness ratio of at least one of said recycled glass product; and
determining if said redness ratio satisfies a predetermined quality control metric; and
adjusting said glass batch formulation if said redness ratio does not satisfy said metric.

12. The method of claim 9, wherein said recycled glass product is an amber beer bottle.

13. A method of recycling mixed color cullet comprising the steps of:
providing a glass cullet supply, wherein at least one glass constituent of said cullet supply contains chromium, or iron, or both.
determining the amount of chromium-containing glass in said glass cullet supply;
determining the amount of iron-containing glass in said glass cullet supply;
determining an effective amount of copper oxide to, at least partially, decolorize said chromium-containing glass and/or said iron-containing glass wherein said effective amount is determined according to a non-linear relationship between at least said chromium-containing glass and said copper oxide.

14. The method of claim 13, wherein said chromium-containing glass comprises Cr₂O₃.

15. The method of claim 13, wherein said iron-containing glass comprises Fe₂O₃.

16. The method of claim 13, further comprising the steps of:
specifying prior to melting of said glass supply, transmission properties of desired resultant glass products;
calculating the desired amount of additional color modifiers;
developing a desired glass formulation; and
creating at least one recycled glass product according to said glass formulation.

17. The method of claim 16, wherein the step of specifying transmission properties of said recycled glass products comprises the steps of specifying a thickness of a recycled glass product made from said determined glass formulation and specifying at least two of: an optical transmission of said recycled glass product at 550 nm (T₅₅₀), an optical transmission of said recycled glass product at 650 nm (T₆₅₀), and a redness ratio (T₆₅₀/T₅₅₀) of said recycled glass product.

18. The method of claim 17, further comprising the steps of:
determining a redness ratio of at least one of said recycled glass product;
determining if said redness ratio satisfies a predetermined quality control metric; and
adjusting said glass batch formulation if said redness ratio does not satisfy said metric.

19. The method of claim 13 wherein said non-linear relationship is in accordance with the following polynomial equation:
Y=X₀+CO*GG*X_{C1}+(0.0021*GG)²*X_{C2}+XS*X_{X1}+XS²*X_{X2}
where:
Y is the amount of copper oxide, as a percent of total glass weight, added to produce an excess redness ratio XS of given value when the chromium and/or iron containing glass content, as a percent of total glass weight, is GG;
CO is the amount of chrome oxide, as a percent of total glass weight, as a percent of total glass weight;
GG is the chromium and/or iron containing glass content of the batch of glass expressed as a percentage of total glass weight;
XS is the desired excess redness ratio of the melted glass defined as the difference between a measured redness ratio (T650/T550) and an amber glass minimum acceptable redness ratio as defined by a target amber glass specification;
X₀ is an intercept with a Y axis;
X_{C1} is a chrome linear value;
X_{C2} is a chrome quadratic value;
X_{X1} is a redness ratio linear value; and
X_{X2} is an excess redness quadratic value.

20. The method of claim 13, further comprising making a redox less reducing to maintain a glass batch produced from said method within a designated 550 nm transmission requirement as the amount of chrome and copper oxide is increased in the glass batch.
